(19) United States
(12) Patent Application Publication
(10) Pub. No.: US 2026/0133039 A1
(43) Pub. Date: May 14, 2026

(54) ROUTE-PLANNING MOBILITY SYSTEM FOR VISUALLY IMPAIRED

(71) Applicant: GM Global Technology Operations LLC, Detroit, MI (US)

(72) Inventors: Joseph Michael Culos, Warren, MI (US); John Marshall Lackowski, Oakland Township, MI (US); Bradley Allen Newcomb, Troy, MI (US); Nathan Thompson, Sterling Heights, MI (US); Steven Jon Yik, Walled Lake, MI (US); Curtis L. Hay, Petoskey, MI (US)

(73) Assignee: GM Global Technology Operations LLC, Detroit, MI (US)

(21) Appl. No.: 18/942,036

(22) Filed: Nov. 8, 2024

(51) Int. Cl. G01C 21/34; G01C 21/36

(52) U.S. Cl. CPC G01C 21/343; G01C 21/3617; G01C 21/362; G01C 21/3626

(57) ABSTRACT

A computer-implemented method includes (i) determining, via location data, a current location of a user, (ii) determining, via the location data, a start location of a user device based on the current location and a destination location of the user device and based on a user input, (iii) identifying, via a pedestrian route planner of a route planning application in communication with a navigation system, a pedestrian route between the start location and the destination location, (iv) identifying, via the navigation system, waypoints between the start location and the destination location, (v) transmitting the pedestrian route to the user device, (vi) issuing, via the route planning application, at least one of i) a haptic feedback protocol and ii) an auditory feedback protocol associated with the waypoints, (vii) receiving, from the user device, pedestrian route data, and (viii) processing the pedestrian route data to determine user behavior.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a route planning system to support people who are visually impaired by using haptic or auditory feedback on a user device.

Users may often utilize a mobile application equipped to provide pedestrian navigation when navigating a new area or if the user is needs assistance in navigation as a result of some form of impairment. For example, some mobile applications may be used to determine a walking path based on a current location and a destination and rely on a user following along the walking path to reach the destination. The user generally looks at a screen of a user device to view the walking path displayed within the mobile application. As the user travels along the walking path, the walking path displayed within the mobile application may update to maintain a current location of the user. In some instances, a navigation voice configured within the mobile application may provide audible feedback to inform the user of navigation directions along the walking path. For example, if the walking path encounters a left turn, the navigation voice may provide audible feedback to the user to indicate the left turn.

Many mobile applications associated with pedestrian navigation require the user to hold the user device in the user's hand to maintain visual and audible interaction with the mobile application. If the user is visually impaired, the user may hold a cane in one hand while holding the user device in the other hand to properly use the mobile application while navigating the walking path. A visually impaired user may be burdened by holding both a cane and mobile device in close enough proximity to follow the audible navigation, which is cumbersome and challenging. Further, if road construction or obstructions are present along the walking path, the mobile application may not update the walking path to avoid the obstruction. As a result, the walking path may no longer reflect a viable pathway to reach the destination location. If the user is visually impaired, the user may unexpectedly encounter the obstruction and be unable to reach the destination location if the mobile application fails to update the walking path. Thus, it is desired to have a mobile application that can seamlessly accommodate a user that is visually impaired.

### SUMMARY

One aspect of the disclosure provides a computer-implemented method. The method, when executed by data processing hardware, causes the data processing hardware to perform operations. The operations include (i) determining, via location data, a current location of a user device relative to a vehicle location of a vehicle, (ii) determining, via the location data, a start location of a user device relative to the vehicle location and based on the current location and a destination location of the user device relative to the vehicle location and based on a user input, (iii) identifying, via a pedestrian route planner of a route planning application in communication with a navigation system, a pedestrian route between the start location of the user device and the destination location of the user device, (iv) identifying, via the navigation system, waypoints between the start location of the user device and the destination location of the user device, (v) transmitting the pedestrian route to the user device, (vi) issuing, via the route planning application, at least one of i) a haptic feedback protocol and ii) an auditory feedback protocol associated with the waypoints, (vii) receiving, from the user device, pedestrian route data associated with the pedestrian route, and (viii) processing the pedestrian route data to determine user behavior.

Implementations of this aspect of the disclosure may include one or more of the following optional features. In some examples, the navigation system includes at least one of a Global Positioning System (GPS), Real-Time Kinematic Positioning (RTK), and a Global Navigation Satellite System (GNSS) chipset. In some further examples, the method further includes updating, continuously, the pedestrian route in response to changes associated with the current location of the user device, the GPS, the GNSS chipset, and RTK.

In some implementations, the method further includes pairing and transmitting between the data processing hardware and the user device via a network.

In some configurations, the haptic feedback protocol and the auditory feedback protocol is further associated with i) the current location of the user device in relation to the pedestrian route, ii) modifications to the pedestrian route, and iii) the user device diverging from the pedestrian route.

In some examples, the haptic feedback protocol and the auditory feedback protocol include a plurality of intensities associated with one or more of the current location of the user device in relation to the pedestrian route, modifications to the pedestrian route, the user device diverging from the pedestrian route, and the waypoints.

In some implementations, the method further includes identifying the pedestrian route based on the user behavior.

In some configurations, the waypoints include at least one of i) obstructions in the pedestrian route, ii) directional changes in the pedestrian route, and iii) intersections in the pedestrian route.

In some examples, the current location of the user device is equivalent to the start location of the user device.

In some implementations, the start location of the user device is input manually.

Another aspect of the disclosure provides a system. The system includes data processing hardware and memory hardware in communication with the data processing hardware. The memory hardware stores instructions that when executed on the data processing hardware cause the data processing hardware to perform operations. The operations include (i) determining, via location data, a current location of a user device relative to a vehicle location of a vehicle, (ii) determining, via the location data, a start location of a user device relative to the vehicle location and based on the current location and a destination location of the user device relative to the vehicle location and based on a user input, (iii) identifying, via a pedestrian route planner of a route planning application in communication with a navigation system, a pedestrian route between the start location of the user device and the destination location of the user device, (iv) identifying the pedestrian route based on user behavior, (v) identifying, via the navigation system, waypoints between the start location of the user device and the destination location of the user device, (vi) transmitting the pedestrian route to the user device, (vii) issuing, via the route planning application, at least one of i) a haptic feedback protocol and ii) an auditory feedback protocol associated with the waypoints, (viii) receiving, from the user device, pedestrian route data associated with the pedestrian route, and (ix) processing the pedestrian route data to determine user behavior.

Implementations of this aspect of the disclosure may include one or more of the following optional features. In some examples, the navigation system includes at least one of a Global Positioning System (GPS), Real-Time Kinematic Positioning (RTK), and a Global Navigation Satellite System (GNSS) chipset.

In some implementations, pairing and transmitting between the data processing hardware and the user device occurs via a network.

In some configurations, the haptic feedback protocol and the auditory feedback protocol is further associated with i) the current location of the user device in relation to the pedestrian route, ii) modifications to the pedestrian route, and iii) the user device diverging from the pedestrian route.

In some examples, the waypoints include at least one of i) obstructions in the pedestrian route, ii) directional changes in the pedestrian route, and iii) intersections in the pedestrian route.

Yet another aspect of the disclosure provides a route planning system for a vehicle. The route planning system includes data processing hardware and memory hardware in communication with the data processing hardware. The memory hardware stores instructions that when executed on the data processing hardware cause the data processing hardware to perform operations. The operations include (i) determining, via location data, a current location of a user device relative to a vehicle location of a vehicle, (ii) determining, via the location data, a start location of a user device relative to the vehicle location and based on the current location and a destination location of the user device relative to the vehicle location and based on a user input, (iii) identifying, via a pedestrian route planner of a route planning application in communication with a navigation system, a pedestrian route between the start location of the user device and the destination location of the user device, (iv) identifying the pedestrian route based on user behavior, (v) identifying, via the navigation system, waypoints between the start location of the user device and the destination location of the user device (vi) transmitting the pedestrian route to the user device, (vii) issuing, via the route planning application, at least one of i) a haptic feedback protocol and ii) an auditory feedback protocol associated with the waypoints, (viii) receiving, from the user device, pedestrian route data associated with the pedestrian route, and (ix) processing the pedestrian route data to determine user behavior.

Implementations of this aspect of the disclosure may include one or more of the following optional features. In some examples, the navigation system includes at least one of a Global Positioning System (GPS), Real-Time Kinematic Positioning (RTK), and a Global Navigation Satellite System (GNSS) chipset. In some further examples, the pedestrian route continuously updates in response to changes associated with the current location of the user device, the GPS, the GNSS chipset, and RTK.

In some implementations, the haptic feedback protocol and the auditory feedback protocol is further associated with i) the current location of the user device in relation to the pedestrian route, ii) modifications to the pedestrian route, and iii) the user device diverging from the pedestrian route.

In some configurations, the waypoints include at least one of i) obstructions in the pedestrian route, ii) directional changes in the pedestrian route, and iii) intersections in the pedestrian route.

### BRIEF DESCRIPTION OF THE DRAWINGS

The drawings described herein are for illustrative purposes only of selected configurations and are not intended to limit the scope of the present disclosure.

FIG. 1 is a perspective view of a controller configured with a route planning application according to the present disclosure, the controller optionally configured as part of a vehicle and/or a user device;

FIG. 2 is a functional block diagram of a route planning system according to the present disclosure;

FIG. 3 is another functional block diagram of the route planning system of FIG. 2;

FIG. 4 is an example schematic of a user walking along a pedestrian route and using a route planning application according to the present disclosure;

FIG. 5 is an example flow diagram for a route planning system according to the present disclosure; and

FIG. 6 is another example flow diagram for the route planning system of FIG. 4.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a Field Programmable Gate Array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and Read-Only Memory (ROM)/Programmable Read-Only Memory (PROM)/Erasable Programmable Read-Only Memory (EPROM)/Electronically Erasable Programmable Read-Only Memory (EEPROM) (e.g., typically used for firmware, such as boot programs). Examples of volatile memory include, but are not limited to, Random Access Memory (RAM), Dynamic Random Access Memory (DRAM), Static Random Access Memory (SRAM), Phase Change Memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

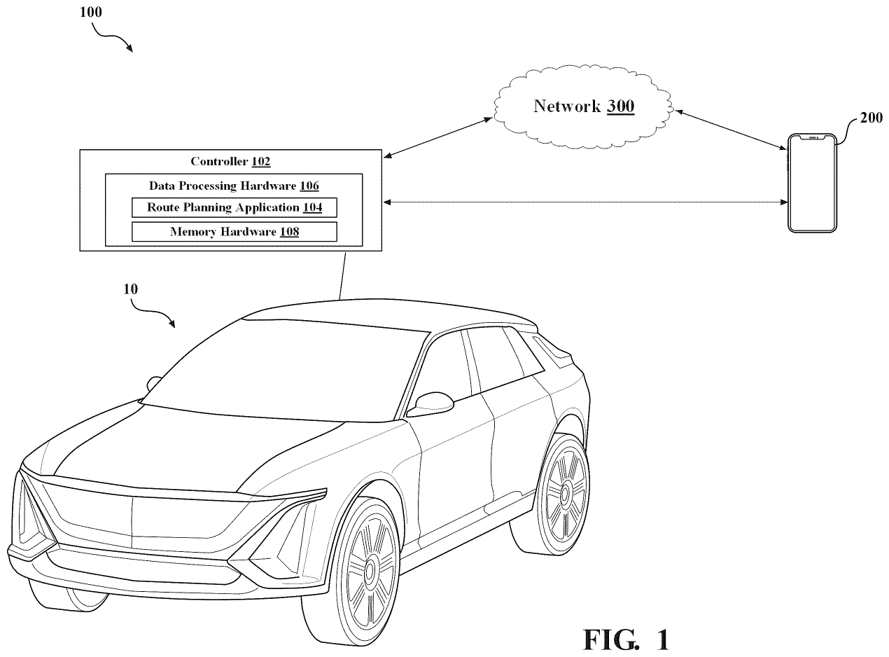

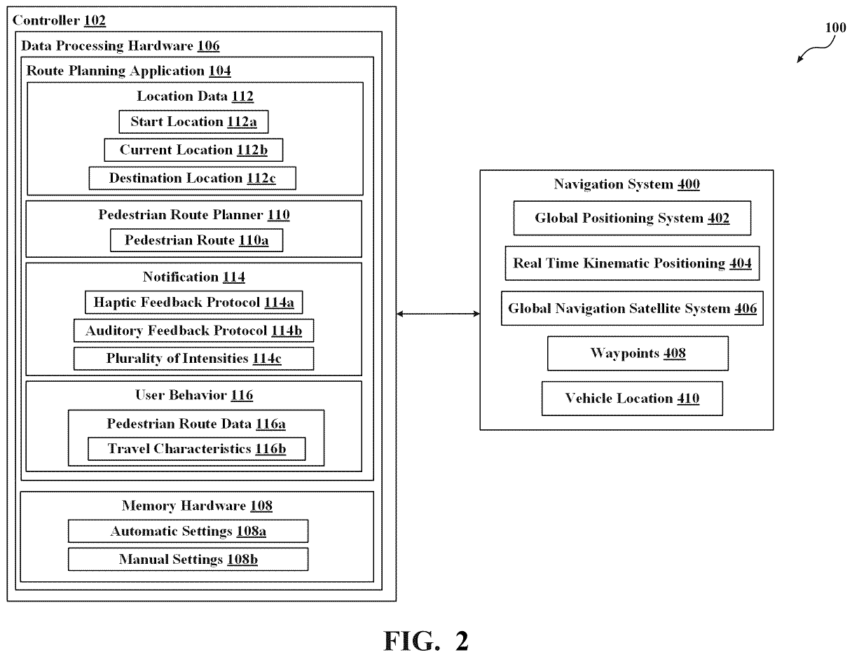

With reference to FIGS. 1 and 2, a route planning system 100 includes a controller 102 configured with a route planning application 104. The controller 102 of the route planning system 100 may be incorporated as part of one or both of a vehicle 10 and a user device 200. Communication and transmission between the controller 102 and the user device 200 may be achieved via pairing or bonding the user device 200 with the controller 102 via a network 300. The vehicle 10 may be an electric vehicle (EV), a hybrid vehicle, an internal combustion engine (ICE) vehicle, or any variety of vehicle that is capable of communication with devices external of the vehicle 10, such as the user device 200, via the network 300.

The controller 102 includes data processing hardware 106 configured to execute the route planning application 104. The controller 102 also includes memory hardware 108 in communication with the data processing hardware 106. The memory hardware 108 stores instructions that when executed on the data processing hardware 106 cause the data processing hardware 106 to perform operations, described herein.

The route planning application 104 includes a pedestrian route planner 110 configured to provide a pedestrian route 110a to a user 12 based on location data 112 input by the user 12 and/or gathered from positioning of the user device 200 and/or the vehicle 10. For example, the location data 112 may include a start location 112a, a current location 112b, and a destination location 112c. The route planning application 104 is configured to generate the pedestrian route 110a between the start location 112a and the destination location 112c, thus enabling the user 12 to follow the pedestrian route 110a until the destination location 112c is reached.

The specific development of the pedestrian route 110a by the pedestrian route planner 110, including how the pedestrian route 110a is selected opposed to selecting other potential routes between the start location 112a and the destination location 112c, is based on a variety of factors that are considered by the route planning application 104. The factors may include, but are not limited to, the shortest distance between the start location 112a and the destination location 112c, the quickest time to travel between the start location 112a and the destination location 112c, the least number of obstructions, hazards, or directional changes between the start location 112a and the destination location 112c, among many other factors.

Further, the pedestrian route 110a includes parameters that are configured to create a safe and optimal pathway for the user 12. Parameters included in the pedestrian route 110a may include, but are not limited to, designating sidewalk boundaries, designating curbs or changes in elevation, designating turns or stops, and the like. The parameters provide the user 12 with a suitable pathway that is optimally configured in terms of efficiency, safety, and clarity, thus enabling the pedestrian to successfully travel along the pedestrian route 110a and ultimately reach the destination location 112c. Other factors and parameters considered by the pedestrian route planner 110 will be described in greater detail below. However, it should be appreciated the pedestrian route planner 110 is configured to select an optimal route based on information provided to and stored at the route planning application 104.

The start location 112a corresponds with an initial location where the user 12 desires the pedestrian route 110a to begin. The pedestrian route 110a is generated by the pedestrian route planner 110 between the start location 112a and the destination location 112c. The user 12 may interact with the route planning application 104 via voice, touch, or otherwise input the start location 112a. Alternatively, the start location 112a may be automatically generated by the route planning application 104. For example, the start location 112a may correspond with and be based on the current location 112b of the user device 200 and, thus, the user 12. In a similar manner, the destination location 112c corresponds with a desired destination to which the user 12 desires to travel. The user 12 may interact with the route planning application 104 via voice, touch, or the like to input the destination location 112c.

The current location 112b corresponds to the real-time location of the user device 200 at any given moment. For example, the current location 112b of the user device 200 may be equivalent to the start location 112a of the user device 200 before travel along the pedestrian route 110a commences. In this regard, the current location 112b may be the start location 112a, the destination location 112c, or any location along the pedestrian route 110a where the user device 200 is located.

The current location 112b of the user device 200 enables the controller 102 to continuously maintain a current position of the user device 200. In this regard, the pedestrian route planner 110 may continuously update the pedestrian route 110a based on the current location 112b of the user device 200, such as when the user device 200 is traveling along the pedestrian route 110a. This allows the pedestrian route 110a to be optimized during operation of the route planning application 104, regardless of where the user device 200 is positioned. For example, the current location 112b of the user device 200 may indicate to the controller 102 that the user device 200 has diverted from the pedestrian route 110a. This may trigger the pedestrian route planner 110 to reconfigure the pedestrian route 110a to accommodate the divergence so the user 12 is still able to reach the destination location 112c.

Further, the route planning application 104 enables hands-free operation by incorporating notifications 114 including a haptic feedback protocol 114a and an auditory feedback protocol 114b. The haptic feedback protocol 114a generates haptic feedback, such as vibrations, at the user device 200. The auditory feedback protocol 114b generates audible feedback, such as sounds or tones, at the user device 200. The haptic feedback protocol 114a and the auditory feedback protocol 114b include instructions associated with the notifications 114 during operation of the route planning application 104. The instructions associated with the notifications 114 may correspond to obstacles, real-time obstructions, and navigation directions along the pedestrian route 110a, which ultimately directs the user 12 to the destination location 112c. In this regard, those who are visually impaired may utilize the route planning system 100 similarly or identically to those who are not visually impaired, the operation and configuration of which will be described in greater detail below.

The notifications 114 include a plurality of intensities 114c. In other words, the haptic feedback protocol 114a may generate haptic feedback at one of the plurality of intensities 114c depending on the notification 114. In a similar manner, the auditory feedback protocol 114b may generate audible feedback at one of the plurality of intensities 114c depending on the notification 114. For example, if the notification 114 indicates the user 12 approaching an edge 14 of a sidewalk 16, while traveling along the pedestrian route 110a, the haptic feedback protocol 114a may cause the user device 200 to vibrate softly once and/or the auditory feedback protocol 114b may cause the user device 200 to emit a single tone. In another example, if the notification 114 indicates the user 12 approaching a pothole in the sidewalk 16 while traveling along the pedestrian route 110a, the haptic feedback protocol 114a may cause the user device 200 to vibrate harshly, such as at a high intensity of the plurality of intensities 114c, once or the auditory feedback protocol 114b may cause the user device 200 to emit two tones. It should be appreciated that the haptic feedback protocol 114a, the auditory feedback protocol 114b, and the plurality of intensities 114c may vary depending on the configuration of the route planning system 100 without deviating from the context of this disclosure.

In another example, the haptic feedback protocol 114a may include instructions for the user device 200 to vibrate once when the user device 200 begins to veer off the pedestrian route 110a, and for the user device 200 to vibrate three times when the user device 200 returns to the pedestrian route 110a. In another configuration, the haptic feedback protocol 114a may include instructions for the user device 200 to vibrate twice when the user device 200 begins to veer off the pedestrian route 110a, and for the user device 200 to vibrate four times when the user device 200 returns to the pedestrian route 110a. In many instances, the haptic feedback protocol 114a is associated with the current location 112b of the user device 200 in relation to the pedestrian route 110a, changes to the pedestrian route 110a, and the user device 200 diverging from the pedestrian route 110a.

In one configuration, the auditory feedback protocol 114b may include instructions for the user device 200 to emit a single audible tone (i.e., the notification 114) once when the user device 200 begins to veer off the pedestrian route 110a and for the user device 200 to emit three audible beeps (i.e., the notification 114) when the user device 200 returns to the pedestrian route 110a. In another example, the auditory feedback protocol 114b may include instructions for the user device 200 to emit two audible notifications 114 when the user device 200 begins to veer off the pedestrian route 110a, and for the user device 200 to emit four audible notifications 114 when the user device 200 returns to the pedestrian route 110a. In many instances, the auditory feedback protocol 114b is associated with the current location 112b of the user device 200 in relation to the pedestrian route 110a, changes to the pedestrian route 110a, and the user device 200 diverging from the pedestrian route 110a.

The route planning application 104 utilizes and stores user behavior 116. The user behavior 116 is configured to obtain pedestrian route data 116a, such as travel characteristics 116b of the user 12 while the route planning application 104 is in operation. For example, the user behavior 116 collects data such as average walking speed of the user 12, instances of the user veering off the pedestrian route 110a, how often the user 12 stops along the pedestrian route 110a, among other data. In this regard, the user behavior 116 may provide the route planning application 104 with information related to the characteristics of the user 12 and how the user 12 interacts with the route planning application 104.

Because every user may offer differing characteristics among other users, the user behavior 116 enables the route planning system 100 to tailor nuances of its operation to each individual user. For example, the user 12 of the route planning application 104 may consistently veer off the pedestrian route 110a when traveling from the start location 112a to the destination location 112c. In this instance, the route planning application 104 may generate the pedestrian route 110a, in subsequent uses of the route planning application 104, along a sidewalk that is away from major roads or roads where vehicles travel at high speeds as a safety precaution. Instead, the pedestrian route 110a may be along a sidewalk that is near minor roads or roads where vehicles travel at low speeds. Tailoring the pedestrian route 110a in subsequent uses of the route planning application 104 based on user behavior 116 allows the route planning system 100 to provide a customized functionality for each individual user.

As stated above, the controller 102 includes the memory hardware 108 in communication with the data processing hardware 106. The memory hardware 108 includes automatic settings 108a and manual settings 108b. The automatic settings 108a of the memory hardware 108 may receive the user behavior 116 of the route planning application 104. The route planning application 104 is configured to tailor the pedestrian route 110a based on the user behavior 116 to optimize the pedestrian route 110a. Therefore, the user behavior 116 is communicated to the automatic settings 108a in the memory hardware 108 of the controller 102. In operation, when the user 12 initiates the route planning application 104, the automatic settings 108a communicate with the route planning application 104 to configure the pedestrian route 110a based on the user behavior 116. This provides the pedestrian route 110a to be as optimal as possible based on each individual user.

The manual settings 108b of the memory hardware 108 include settings that are manually input by the user 12 of the route planning application 104. The manual settings 108b may include, but are not limited to, configuring the user device 200 to vibrate at one of the plurality of intensities 114c when the haptic feedback protocol 114a is triggered, configuring the pedestrian route planner 110 to avoid dirt or gravel pathways when the pedestrian route 110a is developed, among other examples. The manual settings 108b may include any practicable setting associated with the route planning application 104 that may be configured or adjusted by the user 12. The user 12 may adjust the manual settings 108b via interaction with the route planning application 104 at the user device 200. The manual settings 108b are then stored at the memory hardware 108 of the controller 102. This allows the manual settings 108b to be considered by the pedestrian route planner 110 when the pedestrian route 110a is developed.

The route planning system 100 also includes a navigation system 400. The navigation system 400 is included at both the vehicle 10, such as at the controller 102, and at the user device 200. In this regard, the navigation system 400 is enabled to communicate with both the vehicle 10 and the user device 200 and is configured to enhance the functionality of the route planning application 104. For example, the navigation system 400 may assist in developing the pedestrian route 110a by providing information associated with potential routes available between the start location 112a and the destination location 112c, the details of which explained in greater detail below.

The navigation system 400 is configured to retain information related to development of the pedestrian route 110a, including navigational instructions such as, for example, turning left, turning right, stopping at an intersection, distance to a turn, among other examples. The navigation system 400 includes a Global Positioning System (GPS) 402, Real Time Kinematic Positioning (RTK) 404, and a Global Navigation Satellite System (GNSS) chipset 406. Each of the GPS 402, the RTK 404, and the GNSS chipset 406 may work independently or conjunctively to assist in the configuration of the pedestrian route 110a via the pedestrian route planner 110. For example, the GPS 402 and the GNSS chipset 406 may determine a global position of the start location 112a, a global position of the current location 112b of the user device 200, and a global position of the destination location 112c. This “real-world” information related to global positioning enables the pedestrian route planner 110 to develop the pedestrian route 110a using established pathways, roads, navigational instructions, etc. that can be followed by the user 12. The navigation system also maintains a global positioning of the pedestrian route 110a, especially as the user travels along the pedestrian route 110a, thus providing updates in real-time to navigational instructions associated with reaching the destination location 112c. In doing so, the route planning application 104 and the route planning system 100 can operate robustly and optimally.

The navigation system 400 also includes the waypoints 408 that are ultimately incorporated into the pedestrian route 110a. The waypoints 408 may be associated with data obtained from the GPS 402, the RTK 404, the GNSS chipset 406, as well as other navigational instructions and events that occur along the pedestrian route 110a. In other words, the waypoints include, but are not limited to, at least one of obstructions along the pedestrian route 110a, directional changes in the pedestrian route 110a, and intersections in the pedestrian route 110a. In this regard, one of the waypoints 408 may be a road hazard, such as a construction barrel blocking a portion of the pedestrian route 110a. One of the waypoints 408 may be a pothole along the pedestrian route 110a, or a transition between a paved pathway and an unpaved pathway. One of the waypoints 408 may be a left turn, or a right turn, or a stop at an intersection. The waypoints 408 included at the navigation system 400 and integrated into the pedestrian route 110a may vary in quantity and variety depending on what the pedestrian route 110a entails. Further, the waypoints 408 may be modified or altered in real-time at the navigation system 400 based on changes to the waypoints 408 that are locally detected by the user device 200 along the pedestrian route 110a. For example, the user device 200 may detect an obstruction such as a pothole along the pedestrian route 110a. The user device 200 may communicate with the navigation system 400 and classify the pothole as a waypoint 408, enabling the pothole to be integrated into the pedestrian route 110a as a waypoint 408. In this regard, the user device 200 may collect localized information via object detection/recognition to determine waypoints 408 that may not have been captured or captured accurately by the GPS 402, the RTK 404, or the GNSS chipset 406.

Further, the waypoints 408 may associated with at least one of the haptic feedback protocol 114a and the auditory feedback protocol 114b. In this regard, when the user device 200 approaches one of the waypoints 408 along the pedestrian route 110a, the haptic feedback protocol 114a may trigger a notification 114 at the user device 200 in the form of haptic feedback, causing the user device 200 to vibrate when one of the waypoints 408 is nearby or when one of the waypoints 408 is being approached. The haptic feedback protocol 114a may vary in the plurality of intensities 114c depending on the specific type of waypoint 408 that is encountered by the user device 200 along the pedestrian route 110a. For example, the haptic feedback protocol 114a may trigger the notification 114 at the user device 200 to vibrate one time when the waypoint 408 being approached is a construction barrel. In another example, the haptic feedback protocol 114a may trigger the notification 114 at the user device 200 to vibrate two times when the waypoint 408 being approached is a left turn.

In a similar manner, when the user device 200 approaches one of the waypoints 408 along the pedestrian route 110a, the auditory feedback protocol 114b may trigger a notification at the user device 200 in the form of audible feedback, causing the user device 200 to emit a sound or a tone when one of the waypoints 408 is nearby or when one of the waypoints 408 is being approached. The auditory feedback protocol 114b may vary depending on the specific type of waypoint 408 that is encountered by the user device 200 along the pedestrian route 110a. For example, the auditory feedback protocol 114b may trigger the notification 114 at the user device 200 to emit one audible tone when the waypoint 408 being approached is a construction barrel. In another example, the auditory feedback protocol 114b may trigger the notification 114 at the user device 200 to emit two audible tones when the waypoint 408 being approached is a left turn.

The navigation system 400 also includes a vehicle location 410 that maintains a current location of the vehicle 10. Since the navigation system 400 is included at both the vehicle 10 and the user device 200, both the vehicle 10 and the user device 200 receive the vehicle location 410. The vehicle location 410 may assist in operation of the route planning application 104 by maintaining the vehicle location 410 as a reference point when developing the pedestrian route 110a.

The network 300 included with the route planning system 100 enables wireless communication between the vehicle 10, and thus the controller 102, and the user device 200. The network 300 may also enable wireless communication with third party servers outside the route planning system 100. In this regard, information provided by third party servers may be obtained by one or both of the vehicle 10 and the user device 200 and may ultimately be provided to the route planning application 104.

For example, the network 300 may be configured to enable communication with a Continuously Operating Reference Stations (CORS) server 500 to obtain route and traffic data 500a. The route and traffic data 500a at the CORS server 500 is provided by a third party such as, for example, a government-operated, real-time traffic database. In other words, the route and traffic data 500a may provide information related to live traffic updates, such as a car accident that is blocking a pathway, construction updates, road closures, etc. In this regard, the functionality of the route planning application 104 is enhanced due to the route and traffic data 500a provided by the CORS server 500.

The route and traffic data 500a from the CORS server 500 provides navigation data with an extremely high level of precision and accuracy. The network 300 is enabled to transfer the route and traffic data 500a to both the controller 102 included at the vehicle 10 and the user device 200. This further enables the pedestrian route 110a to be as optimal and precise as possible. The route and traffic data 500a may be considered by the pedestrian route planner 110 when developing the pedestrian route 110a. For example, the route and traffic data 500a may indicate a road closure between the start location 112a and the destination location 112c. As a result, the pedestrian route planner 110 may configure the pedestrian route 110a to avoid the road closure. In another example, the route and traffic data 500a may indicate a sudden vehicle accident that occurred along the pedestrian route 110a when the user 12 is already in progress traveling toward the destination location 112c. As a result, the pedestrian route planner 110 may reconfigure the pedestrian route 110a to avoid the vehicle accident, thus enabling the user 12 to reach the destination location 112c in a manner that avoids the vehicle accident.

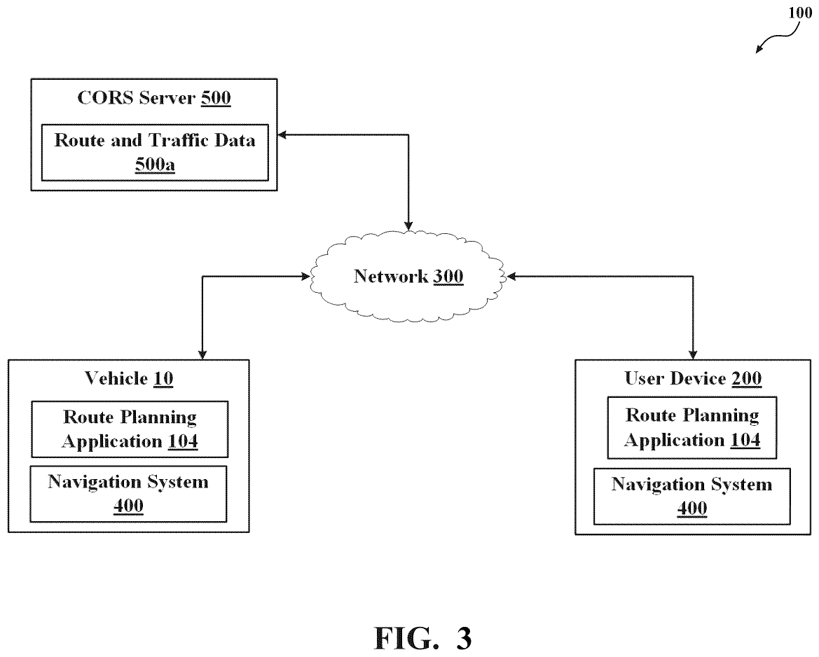

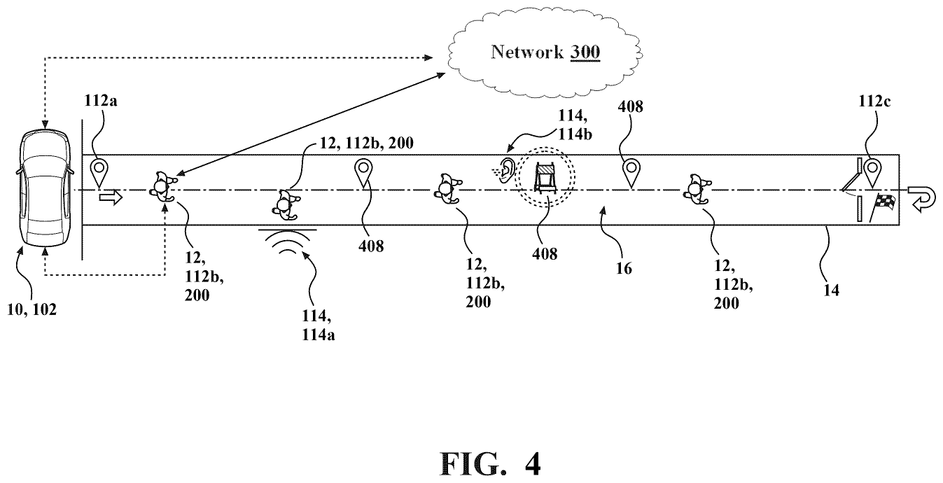

With reference now to FIGS. 1-4, operation of the route planning system 100 relies on the configuration and interaction of the controller 102, the user device 200, the navigation system 400, and the CORS server 500, via the network 300. Enabling operation of the route planning system 100 is performed through the user 12 interacting with the route planning application 104. It should be reaffirmed, however, that the route planning application 104 is included at both the user device 200 and the controller 102 at the vehicle 10. The route planning application 104 may be displayed at the user device 200, thus enabling operation of the route planning application 104 via user interaction with the user device 200. For example, if the user device 200 includes touch-screen capabilities, user interaction with the route planning application 104 may be performed via physical touch of the user device 200. However, it can be appreciated that user interaction with the route planning application 104 may be facilitated by voice recognition features of the route planning application 104 such as, for example, a user speaking into the user device 200 to command operation of the route planning application 104. Further, a combination of physical touch of the user device 200, speaking into the user device 200, or any other means of user interaction with the user device 200, may command operation of the route planning application 104 without deviating from the context of this disclosure.

The current location 112b of the user device 200 further assists the controller 102 in determining that the user device 200 successfully reached the destination location 112c. For example, the controller 102 may utilize the current location 112b of the user device 200 as a confirmation of arrival of the user device 200 at the destination location 112c. The current location 112b of the user device 200 may also provide portions of the pedestrian route data 116a to the controller 102 by comparing the current location 112b of the user device 200, at multiple positions between the start location 112a and the destination location 112c, to the pedestrian route 110a after the destination location 112c has been reached. For example, the pedestrian route data 116a may indicate how accurately the pedestrian route 110a was followed between the start location 112a and the destination location 112c. For example, if the user device 200 partially diverged from the pedestrian route 110a between the start location 112a and the destination location 112c, the current location 112b of the user device 200 will indicate the deviation as part of the pedestrian route data 116a to the controller 102.

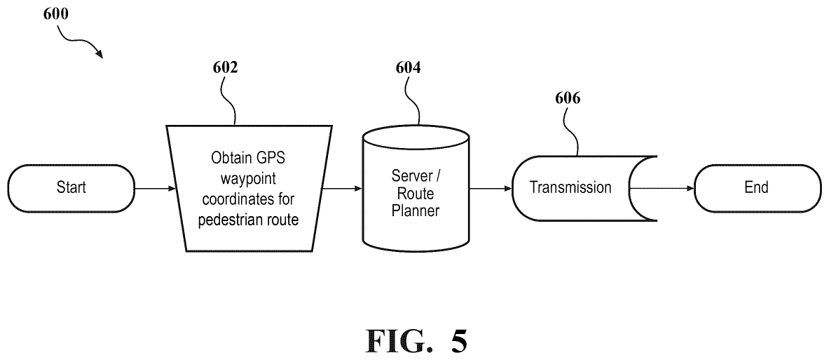

With reference to FIG. 5, a configuration method of the route planning system 100 is provided at 600. Once the start location 112a and the destination location 112c are received by the controller 102, at 602, the coordinates of the waypoints 408 between the start location 112a and the destination location 112c are determined. Determining the coordinates of the waypoints 408 may be accomplished by at least one of the GPS 402, the RTK 404, and the GNSS chipset 406. At 604, the pedestrian route planner 110, in communication with the navigation system 400 and the CORS server 500, generates the pedestrian route 110a. At 606, the pedestrian route 110a is between the controller 102 and the user device 200.

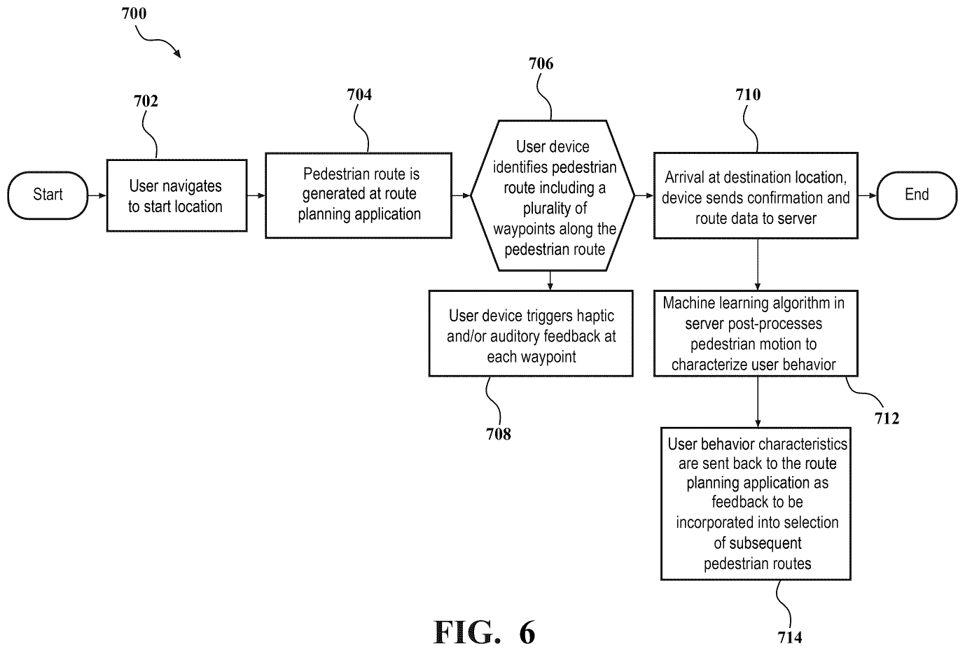

With reference to FIG. 6, an implementation method of the route planning system 100 is provided at 700. At 702, the user navigates to the start location 112a in preparation of traveling to the destination location 112c. At 704, the pedestrian route 110a is generated by the pedestrian route planner 110 included with the route planning application 104. The pedestrian route 110a is identified by user device 200 within the route planning application 104 at 706. Further, the waypoints 408 are also identified and generated within the route planning application 104 along the pedestrian route 110a. The haptic feedback protocol 114a and the auditory feedback protocol 114b are recognized by the route planning application 104 to trigger, at 708, the instructed notifications 114 at each waypoint 408 encountered along the pedestrian route 110a.

At 710, when the user device 200 and, thus, the user 12, arrive at the destination location 112c, the controller 102 confirms a confirmation of arrival at the destination location 112c via the current location 112b of the user device 200 matching the destination location 112c of the user device 200. Further, the current location 112b of the user device 200 enables the user behavior 116 at the route planning application 104 to collect the pedestrian route data 116a associated with the adherence of the user device 200 with the pedestrian route 110a. The pedestrian route data 116a may also include motion characteristics of the user device 200 obtained from the location data 112 when traveling along the pedestrian route 110a, such as to characterize the user behavior 116 via machine learning algorithms and post-processing motion of the user 12 at 712. At 714, the user behavior 116 is stored in the memory hardware 108. During subsequent uses of the route planning application 104, the pedestrian route planner 110 may utilize the user behavior 116 stored in the automatic settings 108a of the memory hardware 108 to further optimize the pedestrian route 110a based on the unique characteristics of the user.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
determining, via location data, a current location of a user device relative to a vehicle location of a vehicle;
determining, via the location data, a start location of a user device relative to the vehicle location and based on the current location and a destination location of the user device relative to the vehicle location and based on a user input;
identifying, via a pedestrian route planner of a route planning application in communication with a navigation system, a pedestrian route between the start location of the user device and the destination location of the user device;
identifying, via the navigation system, waypoints between the start location of the user device and the destination location of the user device;
transmitting the pedestrian route to the user device;
issuing, via the route planning application, at least one of i) a haptic feedback protocol and ii) an auditory feedback protocol associated with the waypoints;
receiving, from the user device, pedestrian route data associated with the pedestrian route; and
processing the pedestrian route data to determine user behavior.

2. The method of claim 1, wherein the navigation system includes at least one of a Global Positioning System (GPS), Real-Time Kinematic Positioning (RTK), and a Global Navigation Satellite System (GNSS) chipset.

3. The method of claim 2, further including updating, continuously, the pedestrian route in response to changes associated with the current location of the user device, the GPS, the GNSS chipset, and RTK.

4. The method of claim 1, further including pairing and transmitting between the data processing hardware and the user device via a network.

5. The method of claim 1, wherein the haptic feedback protocol and the auditory feedback protocol is further associated with i) the current location of the user device in relation to the pedestrian route, ii) modifications to the pedestrian route, and iii) the user device diverging from the pedestrian route.

6. The method of claim 1, wherein the haptic feedback protocol and the auditory feedback protocol include a plurality of intensities associated with one or more of the current location of the user device in relation to the pedestrian route, modifications to the pedestrian route, the user device diverging from the pedestrian route, and the waypoints.

7. The method of claim 1, further including identifying the pedestrian route based on the user behavior.

8. The method of claim 1, wherein the waypoints include at least one of i) obstructions in the pedestrian route, ii) directional changes in the pedestrian route, and iii) intersections in the pedestrian route.

9. The method of claim 1, wherein the current location of the user device is equivalent to the start location of the user device.

10. The method of claim 1, wherein the start location of the user device is input manually.

11. A system comprising:
data processing hardware; and
memory hardware in communication with the data processing hardware, the memory hardware storing instructions that when executed on the data processing hardware cause the data processing hardware to perform operations comprising:
determining, via location data, a current location of a user device relative to a vehicle location of a vehicle;
determining, via the location data, a start location of a user device relative to the vehicle location and based on the current location and a destination location of the user device relative to the vehicle location and based on a user input;
identifying, via a pedestrian route planner of a route planning application in communication with a navigation system, a pedestrian route between the start location of the user device and the destination location of the user device;
identifying the pedestrian route based on user behavior;
identifying, via the navigation system, waypoints between the start location of the user device and the destination location of the user device;
transmitting the pedestrian route to the user device;
issuing, via the route planning application, at least one of i) a haptic feedback protocol and ii) an auditory feedback protocol associated with the waypoints;
receiving, from the user device, pedestrian route data associated with the pedestrian route; and
processing the pedestrian route data to determine user behavior.

12. The system of claim 11, wherein the navigation system includes at least one of a Global Positioning System (GPS), Real-Time Kinematic Positioning (RTK), and a Global Navigation Satellite System (GNSS) chipset.

13. The system of claim 11, wherein pairing and transmitting between the data processing hardware and the user device occurs via a network.

14. The system of claim 11, wherein the haptic feedback protocol and the auditory feedback protocol is further associated with i) the current location of the user device in relation to the pedestrian route, ii) modifications to the pedestrian route, and iii) the user device diverging from the pedestrian route.

15. The system of claim 11, wherein the waypoints include at least one of i) obstructions in the pedestrian route, ii) directional changes in the pedestrian route, and iii) intersections in the pedestrian route.

16. A route planning system for a vehicle, the route planning system comprising:
data processing hardware; and
memory hardware in communication with the data processing hardware, the memory hardware storing instructions that when executed on the data processing hardware cause the data processing hardware to perform operations comprising:
determining, via location data, a current location of a user device relative to a vehicle location of a vehicle;
determining, via the location data, a start location of a user device relative to the vehicle location and based on the current location and a destination location of the user device relative to the vehicle location and based on a user input;
identifying, via a pedestrian route planner of a route planning application in communication with a navigation system, a pedestrian route between the start location of the user device and the destination location of the user device;
identifying the pedestrian route based on user behavior;
identifying, via the navigation system, waypoints between the start location of the user device and the destination location of the user device;
transmitting the pedestrian route to the user device;
issuing, via the route planning application, at least one of i) a haptic feedback protocol and ii) an auditory feedback protocol associated with the waypoints;
receiving, from the user device, pedestrian route data associated with the pedestrian route; and
processing the pedestrian route data to determine user behavior.

17. The route planning system of claim 16, wherein the navigation system includes at least one of a Global Positioning System (GPS), Real-Time Kinematic Positioning (RTK), and a Global Navigation Satellite System (GNSS) chipset.

18. The route planning system of claim 17, wherein the pedestrian route continuously updates in response to changes associated with the current location of the user device, the GPS, the GNSS chipset, and RTK.

19. The route planning system of claim 16, wherein the haptic feedback protocol and the auditory feedback protocol is further associated with i) the current location of the user device in relation to the pedestrian route, ii) modifications to the pedestrian route, and iii) the user device diverging from the pedestrian route.

20. The route planning system of claim 16, wherein the waypoints include at least one of i) obstructions in the pedestrian route, ii) directional changes in the pedestrian route, and iii) intersections in the pedestrian route.
